(19) United States
(12) Patent Application Publication
(10) Pub. No.: US 2010/0047642 A1
(43) Pub. Date: Feb. 25, 2010

(54) FUEL CELL

(75) Inventors: Shinnosuke Koji, Kawasaki-shi (JP); Satoshi Mogi, Yamato-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/508,940

(22) Filed: Jul. 24, 2009

(30) Foreign Application Priority Data
Aug. 20, 2008 (JP) 2008-211446

(51) Int. Cl. H01M 8/04

(52) U.S. Cl. 429/22

(57) ABSTRACT

Provided is a flow type fuel cell including: an anode chamber flow path including a power generation area; a supply flow path connected to one end of the anode chamber flow path, through which the fuel gas is supplied; and an exhaust flow path connected to another end of the anode chamber flow path, through which the fuel gas is exhausted, wherein a variable flow rate controlling unit for changing a flow rate of the fuel gas by water generated by the power generation of the power generation area is disposed within the anode chamber flow path so that the flow rate of the fuel gas can be reduced by the variable flow rate controlling unit during the power generation and for a given period of time after stop of the power generation.

### BACKGROUND OF THE INVENTION

1. Field of the Invention

The present invention relates to a fuel cell.

2. Description of the Related Art

A polymer electrolyte fuel cell includes a polymer electrolyte membrane having proton conductivity and a pair of electrodes disposed on both sides of the polymer electrolyte membrane.

The electrodes include a catalyst layer containing platinum or platinum group metal catalyst and a gas diffusion layer formed on an outer surface of the catalyst layer, for supplying a gas and performing current collection.

An assembly in which a pair of electrodes and the polymer electrolyte membrane are integrally formed is referred to as a membrane electrode assembly (MEA). Electric power is generated by supplying a fuel (hydrogen) to one of the electrodes and an oxidant (oxygen) to another of the electrodes.

A theoretical voltage per fuel cell unit is about 1.23 V. In actual operation, the fuel cell unit is generally used with an output voltage of about 0.7 V.

For that reason, in a case where a higher electromotive voltage is necessary, multiple fuel cell units are stacked with each other and the respective fuel cell units are electrically connected in series to be used. Such a structure is referred to as a fuel cell stack. A fuel cell as used herein refers to both one fuel cell unit and a fuel cell stack.

In order to cause the fuel cell stack to generate electric power efficiently, it is necessary to cause individual fuel cell unit constituting the fuel cell stack to generate electric power efficiently.

For that reason, design and control are necessary so that temperature conditions of the respective fuel cell units and supply of a fuel and an oxidant to the respective fuel cell units are uniform.

Generally, a fuel flow path and an oxidant flow path in a fuel cell stack are formed in parallel with the respective fuel cell units, and the fuel and the oxidant are distributed to the respective fuel cell units in parallel.

In the fuel cell of a type in which hydrogen is used as a fuel, owing to fluctuation of a pressure loss in the fuel flow path of the respective fuel cell units, clogging of the fuel flow path due to condensed water and generated water, or the like, there is a problem of being unable to uniformly supply the fuel gas to the respective fuel cell units.

In a case where the supply of the fuel gas can not be uniformly performed, there occur a shortage of the fuel gas, accumulation of impurity gas within the fuel flow path, such as nitrogen gas invading into the fuel flow path through the membrane electrode assembly, and back flow of the exhaust gas. Due to those phenomena, there was a fear of lowering of performance or degradation of the fuel cell stack.

Japanese Patent Application Laid-Open No. 2007-227365 discloses, as the fuel cell apparatuses capable of realizing uniform supply of the fuel gas and efficient exhaust of the impurity gas, the following fuel cell apparatuses.

In this technology, respective flow path resistances of a branch flow path corresponding to an electric power generating portion, a supply side flow path, and an exhaust side flow path of the fuel cell stack are designed by inserting a choking construction into downstream side of the branch flow path of the fuel cell stack, or the like, whereby the uniform supply of the fuel gas and the efficient exhaust of the impurity gas are realized.

Further, Japanese Patent Application Laid-Open No. 2005-056671 discloses a fuel cell, in which, in order to uniformly supply the fuel to the respective fuel cell units, the respective fuel cell units are stacked so that the pressure loss of the fuel cell unit which is closer to a supply port becomes larger by adjusting a choking valve provided to a gas circulation groove.

As described above, according to the fuel cell apparatus described in Japanese Patent Application Laid-Open No. 2007-227365 as a related example, the uniform supply of the fuel gas to the respective fuel cell units, and the efficient exhaust of the impurity gas may be realized.

However, in the fuel cell apparatus, there is no concern about a time period, which is necessary for fuel gas replacement within the fuel flow path at the time of start up, owing to the pressure losses of the fuel flow paths in the respective fuel cell units owing to the above-mentioned choking construction.

As one of methods for shortening the time period for the fuel gas replacement, there is exemplified a method involving increasing the pressure of the supplied fuel gas. However, from the view points of cost, law regulations, and safety, an upper limit is provided to the pressure of the supplied fuel gas. As a result, there is a limitation of shortening the time period until the fuel cell is ready to start generating power.

In addition, in the fuel cell apparatus described in Japanese Patent Application Laid-Open No. 2005-056671, the choking valve disposed in the gas flow groove is actively controlled, whereby the fuel may be supplied uniformly to the respective fuel cell units. However, there are needed a self-choking valve, a control circuit, a sensor, and the like, resulting in still remaining problems such as upsizing of the fuel cell system and its cost.

### SUMMARY OF THE INVENTION

The present invention is directed to a fuel cell of a flow type which successively exhausts a constant fuel gas during power generation, in particular, a fuel cell capable of uniformly supplying the fuel gas to respective fuel cell units within the fuel cell stack, efficiently exhausting an impurity gas, and of realizing shortening of a replacement time period of the fuel gas, and downsizing of the system.

In order to solve the above-mentioned problems, the present invention provides a fuel cell as constructed as follows.

According to the present invention, there is provided a fuel cell, including a fuel flow path for supplying a fuel gas to a power generation area at which the fuel gas is consumed, the fuel cell being a flow type which successively exhausting a constant fuel gas during power generation of the power generation area, the fuel flow path including: an anode chamber flow path including the power generation area; a supply flow path connected to one end of the anode chamber flow path, through which the fuel gas is supplied; and an exhaust flow path connected to another end of the anode chamber flow path, through which the fuel gas is exhausted, in which a variable flow rate controlling unit for changing a flow rate of the fuel gas by water generated by the power generation of the power generation area is disposed within the anode chamber flow path so that the flow rate of the fuel gas can be reduced by the variable flow rate controlling unit during the power generation and for a given period of time after stop of the power generation.

Note that the term “power generation area” used herein means the area where power generation is conducted in the fuel cell.

According to the present invention, when constructing the fuel cell of the flow type which successively exhausts the constant fuel gas during the power generation, there may be available of uniformly supplying the fuel gas to the respective fuel cell units within the fuel cell stack, efficiently exhausting the impurity gas, and of realizing shortening of the replacement time period of the fuel gas, and downsizing of the system.

Further features of the present invention will become apparent from the following description of exemplary embodiments with reference to the attached drawings.

### BRIEF DESCRIPTION OF THE DRAWINGS

FIG. 1 is a sectional view illustrating a configuration of a fuel cell unit according to Embodiment 1 of the present invention.

FIG. 2 is an enlarged view of a periphery of a variable flow rate controlling unit according to Embodiment 1 of the present invention, which is illustrated in FIG. 1.

FIG. 3 is a schematic view illustrating the structure of a variable flow rate controlling unit according to Embodiment 1 of the present invention.

FIGS. 4A, 4B, 4C, 4D, 4E, 4F and 4G are schematic views illustrating exemplary configurations of the variable flow rate controlling unit according to Embodiment 1 of the present invention.

FIG. 5 is a schematic view illustrating an exemplary configuration of the variable flow rate controlling unit according to Embodiment 1 of the present invention.

FIG. 6 is a schematic view illustrating a recess portion of the variable flow rate controlling unit according to Embodiment 1 of the present invention.

FIGS. 7A, 7B, and 7C are schematic views illustrating exemplary configurations of a variable flow rate controlling unit according to Embodiment 2 of the present invention, in which one surface out of surfaces forming a recess portion is formed from a membrane electrode assembly.

FIGS. 8A, 8B, and 8C are schematic views illustrating exemplary configurations of a variable flow rate controlling unit according to Embodiment 3 of the present invention, in which a porous body having a recess portion and an anode gas diffusion layer are disposed within a flow path so as to be brought into contact with each other.

FIGS. 9A and 9B are schematic views illustrating exemplary configurations of a variable flow rate controlling unit according to Embodiment 4 of the present invention.

FIG. 10 is a schematic view illustrating an exemplary configuration of the variable flow rate controlling unit according to Embodiment 4 of the present invention.

FIG. 11 is a schematic view illustrating a configuration of a fuel cell unit according to Example of the present invention.

FIG. 12 is a perspective view illustrating a construction of an anode collector according to Example of the present invention.

FIG. 13 is an enlarged view of a periphery of the variable flow rate controlling unit according to Example of the present invention, which is illustrated in FIG. 11.

FIG. 14 is a graph illustrating a variation of hydrogen flow rate of the fuel cell during power generation and after stop of the power generation of the fuel cell according to Example of the present invention.

FIG. 15 is a schematic view illustrating a configuration of a fuel cell unit according to Comparative Example of the fuel cell.

FIG. 16 is a graph illustrating a variation of hydrogen flow rate of the fuel cell during power generation and after stop of the power generation of the fuel cell according to Comparative Example of the present invention.

### DESCRIPTION OF THE EMBODIMENTS

Hereinafter, description is made of Embodiments of a flow type fuel cell of the present invention, which includes a fuel flow path for supplying a fuel gas to a power generation area at which the fuel gas is consumed, and successively exhausts a constant fuel gas during power generation of a power generation area with reference to drawings in further detail.

### Embodiment 1

As Embodiment 1, description is made of an exemplary configuration, in which a variable flow rate controlling unit is disposed within the fuel flow path of the fuel cell, and the variable flow rate controlling unit is formed from a porous body having a recess portion.

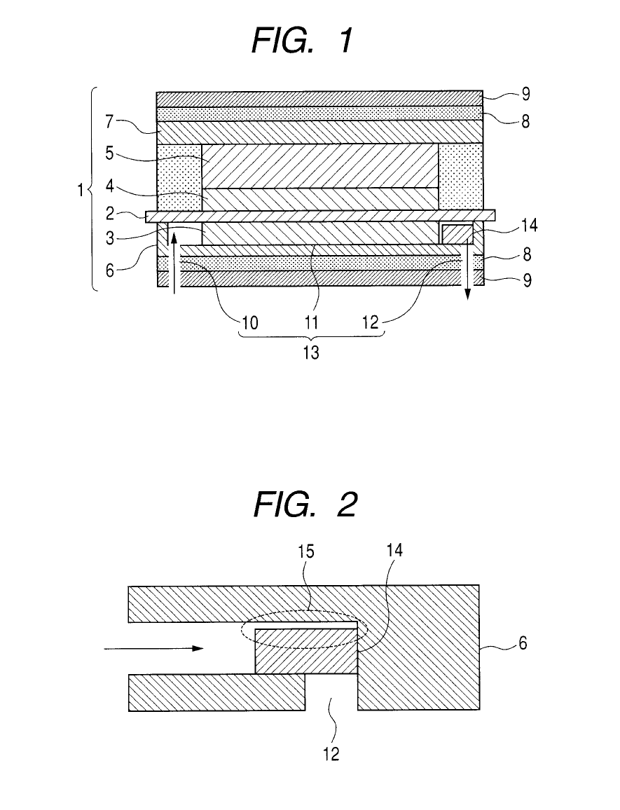

FIG. 1 is a sectional view illustrating a construction of a fuel cell unit according to Embodiment 1 of the present invention. FIG. 2 is an enlarged view of the variable flow rate controlling unit of FIG. 1.

FIG. 1 shows a fuel cell unit 1, a membrane electrode assembly 2, an anode gas diffusion layer 3, a cathode gas diffusion layer 4, an oxidizer supply layer 5, an anode collector 6, a cathode collector 7, an insulating plate 8, and an end plate 9.

Further, FIG. 1 shows a supply flow path 10, an anode chamber flow path 11, an exhaust flow path 12, and a variable flow rate controlling unit 14.

Besides, FIG. 2 illustrates a recess portion 15 of the porous body, which constructs the variable flow rate controlling unit 14. It should be noted that the same reference numeral of FIG. 1 represents the same member as in FIG. 1 in the following figures.

In the exemplary configuration as illustrated in FIG. 1, the fuel cell unit 1 according to this Embodiment includes the flow rate controlling unit 14 on the exhaust flow path 12 side within the anode chamber flow path 11.

Further, the membrane electrode assembly 2 is disposed in the center of the fuel cell unit 1, and the anode gas diffusion layer 3 and the cathode gas diffusion layer 4 are disposed on both sides of the membrane electrode assembly 2, respectively.

As is well known, the membrane electrode assembly 2 is a polymer electrolyte membrane provided with electrodes each containing a catalyst layer and being formed on both sides thereof.

As the polymer electrolyte membrane, generally a perfluorosulfonic acid-based proton exchange resin membrane or the like is used, but the present invention may be implemented independently of kind of the polymer electrolyte membrane.

The catalyst layers formed on both sides of the polymer electrolyte membrane are generally formed of a catalyst which promotes a fuel cell reaction and an electrolyte having proton conductivity, and optionally, a catalyst carrier, a hydrophobic agent, a hydrophilic agent, or the like may be contained therein.

As generally used catalysts, platinum, particulates of a platinum alloy, platinum-carrying carbon, and the like are known, but the present invention may be implemented independently of the kinds of those catalysts.

The anode gas diffusion layer 3 and the cathode gas diffusion layer 4 are layers which are permeable to gases and which are electroconductive.

Specifically, the anode gas diffusion layer 3 and the cathode gas diffusion layer 4 have the function of uniformly and sufficiently supplying a fuel and an oxidant to a reaction region of the catalyst in order to efficiently carry out an electrode reaction and taking charges generated by the electrode reaction out of the cell.

Generally, a porous carbon material is used as the gas diffusion layer, and also in the present invention, such a generally used material may be used.

The oxidizer supply layer 5 is disposed outside the cathode gas diffusion layer 4, and has the functions of supplying the oxidant such as air or oxygen to a surface of the cathode gas diffusion layer 4 and electrically connecting the cathode collector 7 and the cathode gas diffusion layer 4.

Exemplary materials for the oxidizer supply layer 5 include a foamed metal, a porous carbon structure, a metal mesh, and a conductive plate having a groove for supplying the oxidant.

In FIG. 1, a fuel cell in which the oxidizer supply layer 5 is disposed only on the cathode side is illustrated, but the fuel cell may also be constructed such that a fuel supply layer having a similar function is disposed outside the anode gas diffusion layer 3.

In this embodiment, the anode gas diffusion layer 3 serves both functions as a gas diffusion layer and as a fuel supply layer.

The anode collector 6 and the cathode collector 7 are plate-like members formed of a conductive material such as a metal or carbon, and has the function of taking out electrons generated by a fuel cell reaction to the outside.

Therefore, the anode collector 6 and the cathode collector 7 have terminals disposed so as to be brought into contact with the anode gas diffusion layer 3 and the oxidizer supply layer 5, respectively, for taking out the output to the outside.

The insulating plate 8 has the function of electrically insulating between the end plate 9 and one of the anode collector 6 and the cathode collector 7.

The insulating plate 8 may be formed of, for example, a resin. The end plate 9 has the function of uniformly transferring a clamping pressure to the fuel cell.

The end plate 9 may be formed of a rigid material such as stainless used steel (SUS). In the present invention, an exemplary configuration is illustrated in which one of the pair of end plates 9 has the supply flow path 10 and the exhaust flow path 12 of the fuel gas formed therein, but the present invention is not limited to this construction.

The variable flow rate controlling unit 14 is disposed on the exhaust flow path 12 side within the anode chamber flow path 11 of the fuel flow path 13.

The variable flow rate controlling unit 14 has a function of reducing the fuel gas flow rate during the power generation and for a given period of time after stop of the power generation compared to the fuel gas flow rate before power generation or after the stop of the power generation.

Further, the reduced fuel gas flow rate is held at a constant value, but is not zero. Such a function is developed due to the fact that water which was caused on the cathode side by the power generation was back-diffused through the membrane electrode assembly 2 to enter into the anode flow path 11, and the water is condensed in the vicinity of the variable flow rate controlling unit 14.

As a result, a path of the fuel gas that passes through the variable flow rate controlling unit 14 is caused to change to increase the flow path resistances, whereby the flow rate is reduced.

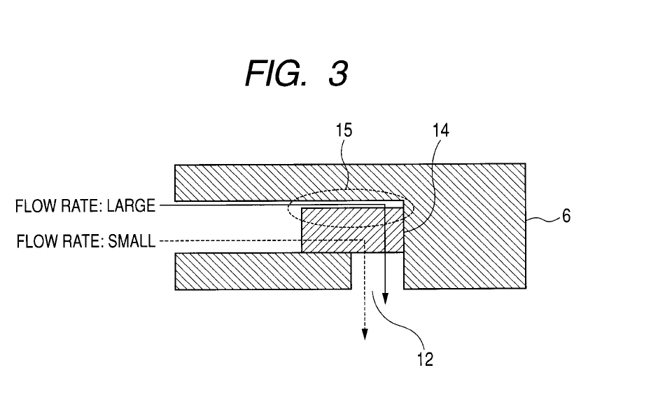

The path of the fuel gas under a dry state before power generation and after power generation and the path of the fuel gas under the swelling state during the power generation and for a given period of time after stop of the power generation are schematically illustrated in FIG. 3.

A solid line represents the path under the dry state, and a dotted line represents the path under the swelling state. When the water caused by the power generation is accumulated in the recess portion 15, the fuel gas, which has been exhausted through the path indicated by the solid line under the dry state, is caused to exhaust through the path indicated by the dotted line.

Owing to change in path as described above, a distance of the porous body (flow path resistor), through which the fuel gas passes, becomes longer. As a result, the flow rate is reduced.

By the provision of the function described above, in addition to effects of the flow rate controlling unit, such as prevention of a back flow of the fuel gas and uniform supply of the fuel gas, as the flow rate at the dry state is large, the fuel gas replacement at the start up time may be quickly carried out.

A lower limit of the flow rate, which is controlled by the variable flow rate controlling unit 14, is determined by the flow rate of the impurity gas entering into the fuel flow path 13.

In this case, the lower limit of the flow rate, which is controlled by the variable flow rate controlling unit 14 indicates a flow rate during the power generation and for a given period of time after stop of the power generation (swelling state).

The flow rate of the impurity gas such as nitrogen, which mainly enters through the membrane electrode assembly 2, becomes largest when the membrane electrode assembly 2 is under a high temperature and high moisture state, such as during the power generation and for a given period of time after the stop of the power generation.

If the flow rate which is controlled by the variable flow rate controlling unit 14 is smaller than the flow rate of the impurity gas that enters into the fuel flow path 13, the impurity gas is gradually accumulated within the fuel flow path 13.

As a result, there is such a fear that the fuel gas concentration within the anode chamber flow path 11 lowers, thereby affecting the performance of the fuel cell, or causing a degradation reaction.

Accordingly, it is required that the lower limit of the flow rate, which is controlled by the variable flow rate controlling unit 14, be larger than the impurity gas flow rate that enters into the fuel flow path 13.

The flow rate before power generation and after power generation (dry state), which is controlled by the variable flow rate controlling unit 14 is determined by the period of time which is required for the fuel gas replacement flowing the fuel flow path 13 within the fuel cell.

The flow rate of the variable flow rate controlling unit 14 under the dry state directly corresponds to the period of time, which is required for the replacement into the fuel gas.

Therefore, in a system in which the fuel gas replacement within a shorter period of time is required, the larger flow rate becomes necessary.

This largely differs depending on the system, the application, or the like of the fuel cell.

The variable flow rate controlling unit 14 is formed from a porous body.

In this case, the porous body refers to a structure, which includes a plurality of pores, and further, includes such communication holes that those pores are coupled from one surface to another surface.

As examples of the porous body, there are exemplified various filters, a mesh, a foamed polymer and a foamed metal, a plurality of pipes having coupled, and the like.

The porous body forming the variable flow rate controlling unit 14 has a shape having the recess portion 15 toward upstream of the flow of the fuel gas.

The recess portion 15 does not refer to the structure, which is formed by the pores of the porous body, but refers to the structure which is formed by the configuration of the porous body. The water caused by the power generation is accumulated within the recess portion 15 so that the path of the fuel gas is caused to change, to thereby change the flow path resistance of the fuel gas.

By the provision of the recess portion 15, the path, which has a lowest flow path resistance for the gas passing through the porous body, passes through the recess portion 15.

Specifically, the flow rate becomes larger before power generation and after power generation (dry state).

On the other hand, during the power generation and for a given period of time after stop of the power generation (swelling state), the water caused by the power generation accumulates in the recess portion 15 to bury the recess portion with the water, and hence the gas becomes unavailable to pass through the recess portion 15 of the porous body.

For that reason, the flow path resistance becomes larger than that of before power generation, resulting in lowering of the flow rate. After the stop of the power generation, if the water burying the recess portion 15 of the porous body is removed, the gas is allowed to pass through the recess portion 15, whereby the flow rate becomes larger again.

Provision of the recess portion 15 by the porous body allows the water caused by the power generation to be trapped within the recess portion 15, and enables to realize the variable flow rate controlling unit 14 in which the flow rate is passively changed.

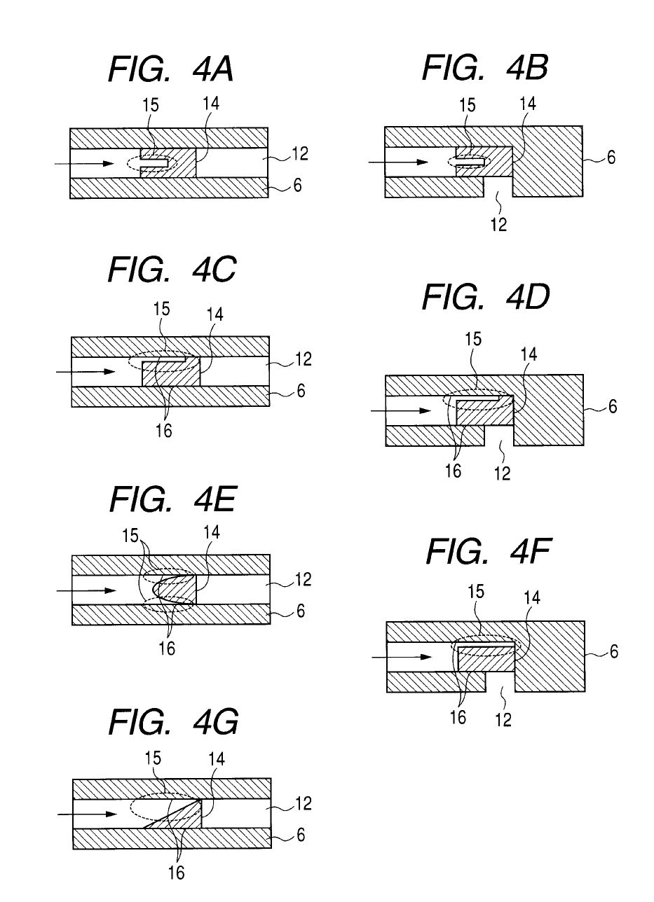

FIGS. 4A to 4G illustrate the exemplary configurations of flow path shapes, in which the variable flow rate controlling unit 14 is formed from the porous body having the recess portion 15.

FIG. 4A is an example in which the recess portion 15 is formed by the porous body 14 disposed in the midway of the anode chamber flow path, and FIG. 4B illustrates an example in which the recess portion 15 is formed by the porous body 14 disposed on the exhaust flow path 12 side of the anode chamber flow path.

Further, FIGS. 4C, 4E, and 4G each illustrate examples in which the recess portion 15 is formed by the porous body 14 disposed in the midway of the anode chamber flow path and a flow path wall 16 of the fuel flow path 13.

Further, FIGS. 4D and 4F each illustrate examples in which the recess portion 15 is formed by the porous body 14 disposed on the exhaust flow path 12 side of the anode chamber flow path and the flow path wall 16 of the fuel flow path 13.

The porous body 14 having the recess portion 15 as described above may have various shapes.

A shortest distance passing through the recess portion 15 toward the exhaust flow path 12 is a path having the lowest flow path resistance. Then, the water caused by the power generation accumulates in the recess portion 15, and the path of the gas passing through the porous body 14 changes, whereby the flow rate is changed.

As illustrated in FIGS. 4C to 4G, one surface out of the surfaces forming the recess portion 15 is formed by the flow path wall 16. As a result, it becomes possible to accumulate the water within the recess portion 15 within the shorter period of time.

The flow path wall 16, generally, includes members such as a separator, an electrode plate, and a collector.

Those members allow the fuel cell to stably conduct the power generation, and hence those members may be cooled in many cases by a cooling system.

Accordingly, as the surface temperature of the flow path wall 16 becomes lower than the surface temperature of the porous body, water is liable to be condensed in the flow path wall 16, resulting in accumulation of the condensed water within the recess portion 15.

In addition, a part of the surface of the flow path wall 16 forming the recess portion 15 is subjected to hydrophilic treatment. As a result, the condensed water may be introduced into the inside of the recess portion 15, thereby being capable of burying the inside of the recess portion 15 with water.

The hydrophilic treatment may be made onto the surface of the flow path wall 16 by using known technologies, for example, plasma treatment, and inorganic material coating treatment, and further by pebbling the surface.

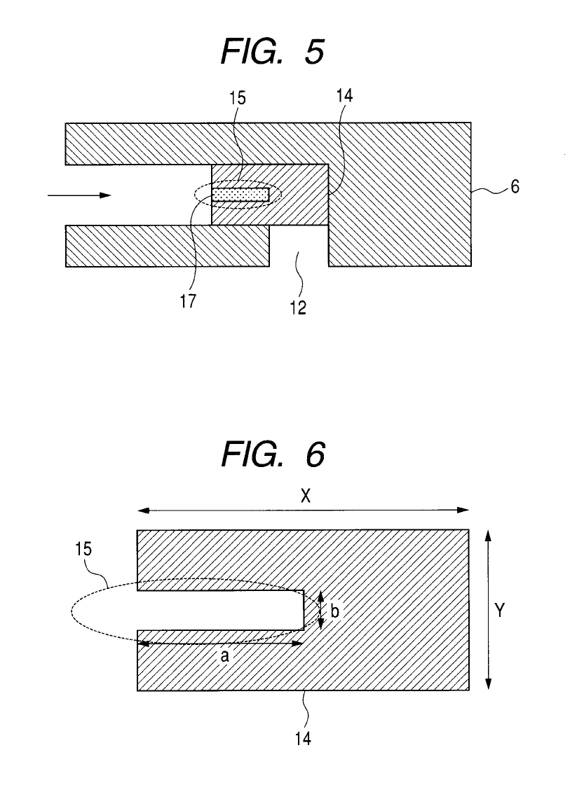

In addition, in order to efficiently collect the water in the recess portion to efficiently change the flow rate, a swelling member 17, which swells by water absorption or moisture absorption to increase a volume thereof, may be disposed inside the recess portion 15 (for example, configuration as illustrated in FIG. 5).

By disposing the swelling member 17 inside the recess portion 15, not only the condensed moisture but also a gaseous moisture may be trapped by the swelling member 17, resulting in being capable of changing the flow rate within a shorter period of time.

The swelling member 17 is capable of absorbing and holding water molecules of from several tens to several thousands times of its own weight, and there is exemplified, for example, a resin having a network structure into which an ionic functional group is introduced.

There are exemplified a polyacrylic acid salt-based polymer resin containing acrylamide-acrylic acid, one containing as a main component a polymer resin such as a starch-acrylonitrile copolymer, a modified alkylene oxide resin, and the like.

As the swelling member 17, materials other than described above may be used as long as having swelling property.

As the shapes of those polymer resins, there are given a powder type, a pellet type, a fiber type, a sheet type, a sponge type, a pearl type (spherical), a cluster type (spherical aggregate), or the like.

It is preferred that the polymer resins having those types be immobilized to be used so as to be free from outgoing from an inside of the recess portion to the flow path.

Besides, one which is obtained by mixing, being carried, or by attaching those polymer resins to other thermoplastic resins may be used.

When being swelled by absorbing moisture or by absorbing water, the gas resistance inside the recess portion 15 is raised, and hence any form of the swelling member 17 may be used as long as being capable of changing the path of the fuel gas.

In addition, of those swelling members 17, the swelling member 17, which easily absorbs the moisture or water and easily releases the water, is preferred, because of being capable of coping with on-off of the fuel cell within a short period of time.

Description is made of an optimal size of the recess portion with reference to FIG. 6.

FIG. 6 illustrates a diagram in which the porous body having the recess portion is disposed within a flow path having a circular cross-section. The diagram is drawn as X>Y and a>b. As the preferred functions of the variable flow rate controlling unit 14, the following are required:
(1) the difference of the flow rates before power generation and during the power generation be large; and
(2) the flow rate be controlled just after the start of the power generation.

In order to realize the above-mentioned item (1), it is preferred that “a” and “b” be large as much as possible.

However, in order to realize the above-mentioned items (1) and (2) at the same time, if “a” and “b” are made large, it takes much period of time for burying the recess portion with water, because the volume of the recess portion is large.

For that reason, it is required that one of “a” and “b” be small. The volume of the recess portion is, as represented by the following Equation 1, multiplied with the square of b, and hence if “b” is made smaller, the above-mentioned items (1) and (2) are efficiently compatible.

Volume of recess portion=a×π(b/2)² (Equation 1)

Accordingly, by setting an aspect ratio of the recess portion to satisfy a>b, the desired variable flow rate controlling unit 14 may be obtained.

As the aspect ratio becomes larger, the volume of the recess portion 15 becomes smaller, thereby being capable of shortening the time period from the start of the power generation to the start of control of the flow rate.

### Embodiment 2

As Embodiment 2, descriptions are made of exemplary configurations in which the variable flow rate controlling unit disposed within the fuel flow path of the fuel cell is formed from the porous body having the recess portion, and a part of the recess portion is formed from the membrane electrode assembly.

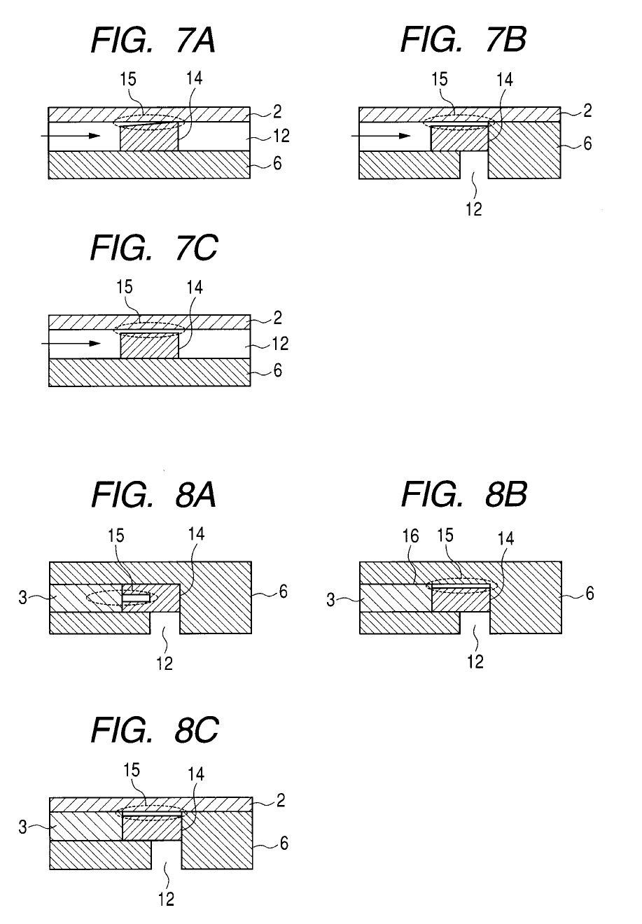

FIGS. 7A to 7C are schematic views each illustrating exemplary configurations of the variable flow rate controlling unit according to this embodiment, in which one surface out of surfaces forming the recess portion is formed from the membrane electrode assembly.

FIGS. 7A and 7C are diagrams each illustrating examples in which the recess portion is formed in the midway of the anode chamber flow path, and FIG. 7B is a diagram illustrating an example in which the recess portion is formed on the exhaust flow path 12 side of the anode chamber flow path.

By taking the configuration as in this embodiment, the water caused by the power generation is absorbed by the membrane electrode assembly 2 to be swelled, and the recess portion 15 is buried with water. As a result, the path of the fuel gas may change to reduce the flow rate.

As in Embodiment 1, by taking such a configuration in which the membrane electrode assembly 2 is used, in place of water, for burying the recess portion 15 having a low flow path resistance, the variable flow rate controlling unit 14 may be realized without conducting hydrophilic treatment of the surface of the flow path wall 16 and without using the swelling member 17.

In addition, the swelling rate of the membrane electrode assembly 2 is determined based on the kind of the membrane and the conditions of the power generation, and hence the size of the recess portion 15 may easily be determined.

For example, as the electrolyte membrane constituting the membrane electrode assembly, if NRE-212 (manufactured by DuPont) is used, the swelling rate of the membrane is in the order of 10 to 15% (when being soaked under conditions of from 23° C. and 50% RH to water of from 23° C. to 100° C.).

Therefore, as the thickness of the membrane electrode assembly 2 is about 50 μm, the size of the recess portion 15 (gap between porous body and membrane electrode assembly under dry state) may be set to about 7.5 μm or less.

Further, in this embodiment, in addition to burying the recess portion 15 by the swelling of the membrane electrode assembly 2, by burying the recess portion 15 with the water caused by the power generation, the flow rate may be changed.

If the swelling of the membrane electrode assembly 2 is only used, precise designing of the gap between the porous body 14 and the membrane electrode assembly 2 is required as described above.

In addition to the swelling of the membrane electrode assembly 2, by combining the blocking of the recess portion 15 by water, allowance may be provided for the designing of the distance between the porous body 14 and the membrane electrode assembly 2. As a result, the variable flow rate controlling unit 14 may more easily be realized.

### Embodiment 3

As Embodiment 3, descriptions are made of exemplary configurations in which the variable flow rate controlling unit disposed within the fuel flow path of the fuel cell is formed from the porous body having the recess portion, and the variable flow rate controlling unit is disposed so as to be partly in contact with the anode gas diffusion layer.

FIGS. 8A to 8C are schematic views illustrating exemplary configurations of the variable flow rate controlling unit according to Embodiment 3 of the present invention, in which the porous body having the recess portion 15 and the anode gas diffusion layer 3 are disposed within a flow path so as to be brought into contact with each other.

FIG. 8A illustrates a case in which the recess portion 15 is made from the porous body, FIG. 8B illustrates a case in which one of the surfaces forming the recess portion is formed from the flow path wall 16, and FIG. 8C illustrates a case in which one of the surfaces forming the recess portion 15 is formed from the membrane electrode assembly 2.

The porous body 14 is needed to be disposed so as to be in contact with the anode gas diffusion layer 3 while maintaining the recess portion 15.

By disposing the porous body 14 and the anode gas diffusion layer 3 so as to be in contact with each other, for example, in a case where the power generation is carried out for a long period of time under a wet condition, it is possible to prevent complete blocking of the flow path from occurring due to generation of excess condensed water between the porous body 14 and the anode gas diffusion layer 3.

By disposing the porous body 14 and the anode gas diffusion layer 3 so as to be partly in contact with each other, the porous body 14 may be disposed under temperature condition which is close to that of the power generation area (anode gas diffusion layer 3), thereby being capable of preventing the condensation from occurring.

Further, the porous body 14 and the anode gas diffusion layer 3 are brought into contact with each other, and hence the space at which the condensation occurs may be eliminated. As a result, the condensation occurs only in the recess portion 15 of the porous body 14, thereby being capable of preventing the complete blocking of the flow path from occurring.

According to the configuration of this embodiment, it becomes possible to select the operation condition of the fuel cell from wider operation conditions of from the dry to the wet.

### Embodiment 4

As Embodiment 4, descriptions are made of exemplary configurations in which the variable flow rate controlling unit disposed within the fuel flow path of the fuel cell is formed from a plurality of the porous bodies.

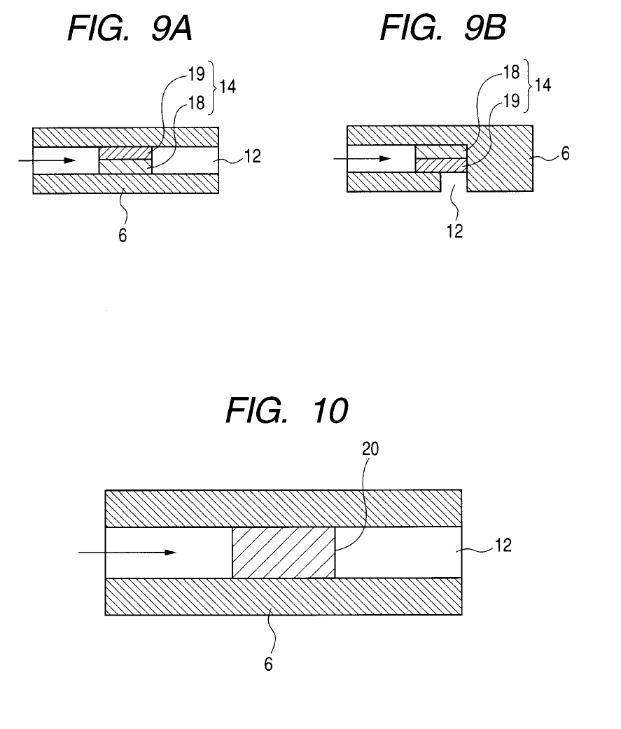

FIGS. 9A and 9B are schematic views illustrating exemplary configurations of the variable flow rate controlling unit according to this embodiment.

FIG. 9A is a diagram illustrating an example in which the variable flow rate controlling unit is formed in the midway of the anode chamber flow path, and FIG. 9B is a diagram illustrating an example in which the variable flow rate controlling unit is disposed on the exhaust flow path 12 side of the anode chamber flow path.

As illustrated in FIGS. 9A and 9B, two porous bodies having different affinities to water caused by the power generation are disposed within the fuel flow path, whereby the variable flow rate controlling unit may be realized.

For example, the flow path resistance of the porous body having high affinity to water is set as small, and the flow path resistance of the porous body having low affinity to water is set as large. As a result, the flow rate during the power generation and for a given period of time after stop of the power generation may be reduced.

The two porous bodies are arranged in parallel with the gas flow within the fuel flow path, thereby being capable of functioning as the variable flow rate controlling unit.

The two porous bodies having different affinities to water are arranged, as illustrated in the drawing, in parallel with the gas flow so as to overlap with each other. If the power generation starts, water is accumulated with priority within the porous body 18 having high affinity to water, resulting in blocking the pores.

As a result, the gas is exhausted only through the porous body 19 having low affinity to water, and hence the flow rate is reduced.

In this case, the porous body 18 having high affinity to water refers to a porous body having property of capable of easily absorbing the water into inside of the pores of the porous body, whereby the flow path resistance of the porous body largely increases by the absorbing of the water.

For example, there are exemplified a porous body having hydrophilicity, a porous body including a water absorbing member or a moisture absorbing member inside the pores, and a porous body being relatively low temperature and being liable to cause condensation inside the pores compared to a porous body having low affinity.

On the other hand, compared to the porous body 18 having high affinity to water, the porous body 19 having low affinity to water is a porous body having property of hardly absorbing the water into inside the pores, and hence, even in the power generation, the inside of the pores is free from being filled with the water.

For example, there are exemplified a water repellent porous body, a porous body being relatively high temperature and being less-liable to cause the condensation inside the pores, and the like.

The variable flow rate controlling unit 14 may be realized by disposing the porous body 18 having high affinity to water and the porous body 19 having low affinity to water, as described above, so as to overlap with each other.

By taking such a configuration, the flow path resistance of the porous body 18 having high affinity to water determines the flow rate before power generation and after power generation (dry state), and the flow path resistance of the porous body 19 having low affinity to water determines the flow rate during the power generation and for a given period of time after the stop of the power generation (swelling state).

Accordingly, in order to obtain a desired variable flow rate controlling unit 14, the flow path resistances and the thicknesses of the two porous bodies (18, 19) may appropriately be selected.

In this case, there was described a case in which the variable flow rate controlling unit 14 is formed from the two porous bodies, but the variable flow rate controlling unit 14 may optionally be formed from three or more of the porous bodies.

Further, as illustrated in FIG. 10, the porous body 20 having a plurality of pore size distribution peaks including the large pores and the small pores may be disposed within the flow path.

The large pores determine the flow rate before power generation and after power generation (dry state), and the water is trapped into the large pores to be blocked.

The small pores determine the flow rate during the power generation and for a given period of time after the stop of the power generation (swelling state), resulting in a state in which the flow rate is reduced compared to the dry state.

As the porous body having two or more of the pore size distribution peaks, there is exemplified a structure, such as a foamed metal, having micro pores at its skeleton.

### EXAMPLE

Hereinafter, description is made of a configuration of the fuel cell unit according to Example of the present invention, in which the variable flow rate controlling unit was disposed by using a hydrophilic PTFE filter having the recess portion.

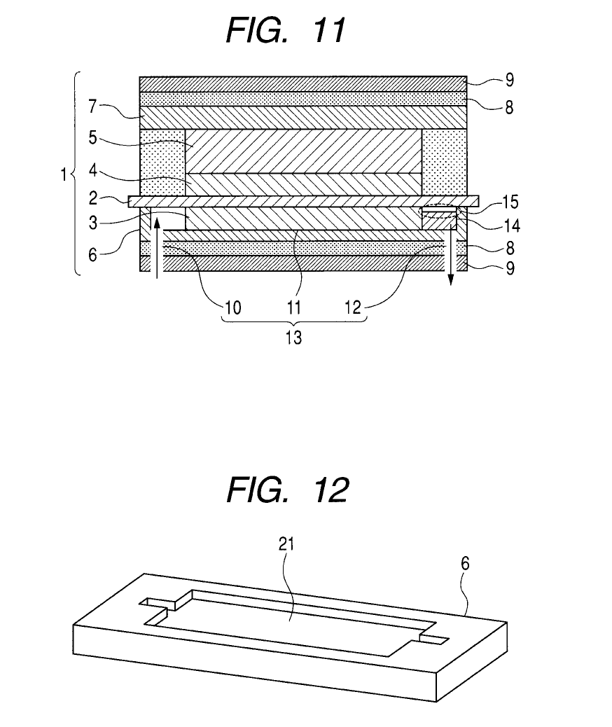

FIG. 11 is a schematic view illustrating a configuration of the fuel cell unit according to this example.

In FIG. 11, the same reference numeral is used for the same configuration as illustrated in FIG. 1, which is described in Embodiment 1, descriptions of common parts are omitted.

In this example, a Nafion membrane (NRE-212, manufactured by DuPont) was used as the polymer electrolyte membrane.

As the catalyst layer, a catalyst layer containing dendrite platinum obtained by appropriate reduction treatment of a dendrite formed of a platinum oxide was used.

As a base material for forming the dendrite formed of a platinum oxide, a PTFE sheet (Nitofron, manufactured by NITTO DENKO CORPORATION) was used, and the dendrite formed of a platinum oxide which is a catalyst precursor was formed thereon at a thickness of 2 μm by reactive sputtering.

The amount of the carried Pt in this case was 0.68 mg/cm². Note that the amount of the carried Pt was determined by X-ray fluorescence spectrometry.

The reactive sputtering was carried out under conditions of a total pressure of 4 Pa, an oxygen flow rate ratio (QO₂/(QAr+QO₂)) of 70%, a substrate temperature of 25° C., and an applied power of 4.9 W/cm².

After subjecting the obtained dendrite formed of a platinum oxide to appropriate hydrophobic treatment, a proton conductive electrolyte was applied thereon.

The proton conductive electrolyte was a five-fold dilution of a 5 wt. % Nafion (registered trademark) (manufactured by Wako Pure Chemical Industries, Ltd.) solution diluted with isopropyl alcohol (reagent, manufactured by Wako Pure Chemical Industries, Ltd.). After applying the proton conductive electrolyte at a rate of 10 μl/cm², a solvent was volatilized to form the catalyst layer.

The obtained catalyst layer was cut out, and hot pressing was carried out with the catalyst layer being disposed on both sides of the polymer electrolyte membrane (at 4 MPa and at 150° C. for 30 minutes) to obtain the membrane electrode assembly.

Carbon cloth (manufactured by E-TEK Inc. with the anode being LT2500-W and the cathode being LT1200-W) was used as the anode gas diffusion layer and the cathode gas diffusion layer, and a foamed metal (CELMET #5 manufactured by Sumitomo Electric Industries, Ltd.) was used as the oxidant supply layer.

A processed SUS plate was used as the anode and cathode current collectors. A processed SUS plate with gold plating thereon for decreasing the contact resistance applied on the surface thereof was used.

FIG. 12 is a perspective view illustrating a construction of the anode current collector.

A recess portion at a depth corresponding to the thickness of the anode gas diffusion layer 3 was dug in the anode collector 6. The anode chamber flow path 11 was adapted to be filled with the anode gas diffusion layer 3.

In this construction, the anode gas diffusion layer functions as the anode chamber flow path. The flow rate of hydrogen in the anode chamber flow path 11 filled with the anode gas diffusion layer 3 was about 0.5 ml/sec when hydrogen was supplied at a pressure of 0.1 MPa.

As the variable flow rate controlling unit, a hydrophilic PTFE filter (manufactured by Millipore, Omnipore 0.1 μm) was used.

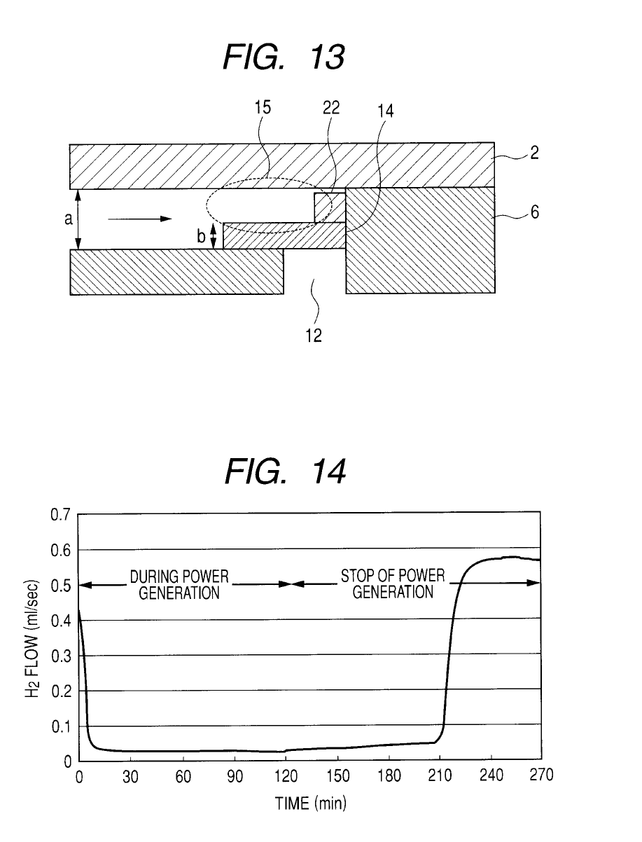

FIG. 13 is an enlarged view illustrating a periphery of the variable flow rate controlling unit of this example as illustrated in FIG. 11.

As illustrated in FIG. 13, the hydrophilic PTFE filter was disposed at a position which was adjacent to a side surface of the anode side gas diffusion layer at the downstream within the anode chamber flow path, and a space was provided between the electrolyte membrane and the filter. Then, the recess portion was formed from the electrolyte membrane and the filter.

Sealing was conducted using a sealing member 22 (manufactured by 3M, silicon-based adhesive) so as to prevent the gap between the flow path and the filter from occurring. A width of the flow path (corresponding to “a” of FIG. 13) was 0.4 mm, and a thickness of the filter (corresponding to “b” of FIG. 13) was 60 μm.

When joining the fuel cell units, the membrane electrode assembly 2 entered into the anode chamber flow path side, and hence the size of the recess portion became a little smaller than that which was determined by the width of the flow path and the thickness of the filter.

The hydrogen flow rate after installation of the variable flow rate controlling unit was almost unchanged before the installation, which was about 0.5 ml/sec when the hydrogen pressure was supplied at 0.1 MPa.

The above-mentioned members were used to manufacture the fuel cell illustrated in FIG. 11, and the fuel cell characteristics were evaluated.

The evaluation was conducted with a constant current of 350 mA/cm² at a temperature of 25° C. with the relative humidity being 50% when pure hydrogen without adding humidity thereto was supplied to the anode at a pressure of 0.1 MPa under a state in which a fixed amount of airflow was supplied to the cathode.

The power generation was carried out for 120 minutes, and hydrogen was continuously supplied thereto after the stop of the power generation to investigate the change of the flow rate by the variable flow rate controlling unit.

FIG. 14 is a graph illustrating a variation of hydrogen flow rate of the fuel cell during power generation and after stop of the power generation of the fuel cell according to this example.

The hydrogen flow rate, which is the order of about 0.5 ml/sec before power generation was reduced until the order of about 0.03 ml/sec when the power generation was started.

Compared to the power generation, the flow rate was reduced by about 1/17, but was not reduced into zero.

This is considered because the water caused by the power generation was accumulated within the recess portion formed from the electrolyte membrane and the porous body, and the path of the fuel gas was changed, whereby the flow rate was largely reduced.

During the power generation for 120 minutes, the fuel cell unit voltage of the fuel cell was stable, and affect of the variable flow rate controlling unit to the performance of the fuel cell was not observed.

It was found that, during about 90 minutes after the stop of the power generation, the flow rate was slightly increased.

This seems to show the appearance in which the water which entered into the pores of the porous body and the water inside the recess portion were gradually rid thereof, and the appearance in which the electrolyte membrane was dried.

The reason why the flow rate was sharply increased after an elapse of 90 minutes after the stop of the power generation is considered because the water within the recess portion was completely removed, whereby the flow path of the fuel gas was returned to a state of before power generation. The flow rates of the fuel gas passing through the flow path before and after of the power generation were the same.

### COMPARATIVE EXAMPLE

As Comparative Example, in the fuel cell of Example described above, the fuel cell unit was configured in which the flow rate controlling unit was disposed without providing the recess portion.

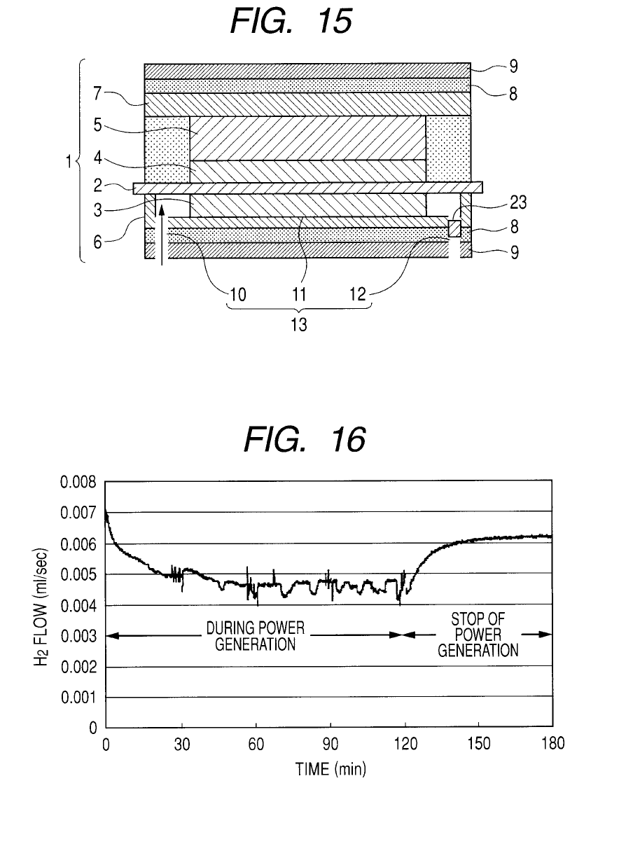

FIG. 15 is a schematic view illustrating a configuration of the fuel cell unit according to Comparative Example of the fuel cell.

As illustrated in FIG. 15, the fuel cell, in which the flow rate controlling unit 23 having no recess portion was disposed on the exhaust flow path 12 side within the anode chamber flow path 11, was exemplified as Comparative Example.

As the flow rate controlling unit, five sheets of cellulose mixture ester type membrane filters (A010, manufactured by ADVANTEC) were laminated and disposed within the flow path.

Except the position of the flow rate controlling unit 23, the kind of the porous body, and with or without the recess portion, the fuel cell had the same configuration with the above-mention Example.

The hydrogen flow rate of the anode chamber flow path 11 before disposing the flow rate controlling unit became about 0.5 ml/sec when the hydrogen pressure was supplied by 0.1 MPa, and the hydrogen flow rate after the disposition was reduced until about 0.01 ml/sec.

FIG. 16 is a graph illustrating a variation of hydrogen flow rate of the fuel cell during power generation and after the stop of the power generation of the fuel cell according to Comparative Example.

Compared to before power generation, the hydrogen flow rate during the power generation was slightly reduced, but was kept unchanged at an order of about 0.01 ml/sec.

The reason why the flow rate was slightly reduced is considered because the generated water entered into the pores within the filter which being the flow rate controlling unit.

After the stop of the power generation, it was also confirmed that the hydrogen flow rate was gradually returned to the same level before power generation.

This seems to show the appearance in which the water, which entered into the pores of the porous body, was gradually rid thereof. The flow rates of the fuel gas before and after of the power generation were the same.

As described above, by forming the recess portion in the flow rate controlling unit configured by the porous body, the variable flow rate controlling unit could be realized as in Examples described above.

Further, the flow rate under the dry state and the flow rate under the wet state became larger. As a result, the fuel gas replacement at the start up time could be realized within a short period of time, and during the power generation, stable operation could be realized owing to a rectifying effect of the fuel gas.

In addition, by disposing the variable flow rate controlling unit having the recess portion, in the above-mentioned Example, the time period required for the fuel gas replacement at the start up time could be shorten by about 1/50 compared to Comparative Example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-211446, filed Aug. 20, 2008, which is hereby incorporated by reference in its entirety.

What is claimed is:

1. A fuel cell, comprising a fuel flow path for supplying a fuel gas to a power generation area at which the fuel gas is consumed,
the fuel cell being a flow type which successively exhausting a constant fuel gas during power generation of the power generation area,
the fuel flow path comprising: an anode chamber flow path including the power generation area; a supply flow path connected to one end of the anode chamber flow path, through which the fuel gas is supplied; and an exhaust flow path connected to another end of the anode chamber flow path, through which the fuel gas is exhausted, wherein
a variable flow rate controlling unit for changing a flow rate of the fuel gas by water generated by the power generation of the power generation area is disposed within the anode chamber flow path so that the flow rate of the fuel gas can be reduced by the variable flow rate controlling unit during the power generation and for a given period of time after stop of the power generation.

2. The fuel cell according to claim 1, wherein the variable flow rate controlling unit is formed from a porous body disposed within the anode chamber flow path, and a recess portion for storing water to be generated by the power generation is formed by the porous body toward upstream of a flow of the fuel gas.

3. The fuel cell according to claim 2, wherein at least one surface of the recess portion out of surfaces forming the recess portion comprises a flow path wall of the fuel flow path.

4. The fuel cell according to claim 3, wherein in the flow path wall, at least a part of the surfaces of the recess portion is hydrophilic.

5. The fuel cell according to claim 2, wherein at least one surface of the recess portion out of the surfaces forming the recess portion comprises a membrane electrode assembly.

6. The fuel cell according to claim 2, wherein the recess portion comprises a swelling member inside the recess portion, which swells by water absorption or moisture absorption to increase a volume thereof.

7. The fuel cell according to claim 2, wherein the porous body is disposed on an exhaust flow path side of the anode chamber flow path.

8. The fuel cell according to claim 7, wherein the porous body is disposed so as to be partially in contact with an anode gas diffusion layer provided in the anode chamber flow path.

9. The fuel cell according to claim 1, wherein the variable flow rate controlling unit comprises a plurality of the porous bodies disposed within the anode chamber flow path, and at least one of the porous bodies has a property in which water is easily absorbed inside the pores, and at least one of the porous bodies has a property in which water hardly intrudes inside the pores.

10. The fuel cell according to claim 1, wherein the variable flow rate controlling unit comprises a porous body disposed within the anode chamber flow path, and the porous body comprises a porous body having a plurality of pore size distribution peaks of large pores and small pores.
